(19) United States
(12) Patent Application Publication
(10) Pub. No.: US 2008/0170001 A1
(43) Pub. Date: Jul. 17, 2008

(54) Plasma display and associated driver

(76) Inventor: Yoo-Jin Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/987,068

(22) Filed: Nov. 27, 2007

(30) Foreign Application Priority Data
Jan. 12, 2007 (KR) 10-2007-0003862

(51) Int. Cl. G09G 3/28; G09G 5/00

(52) U.S. Cl. 345/60; 345/211

(57) ABSTRACT

A display driver includes a first circuit configured to supply a first voltage and a second voltage to at least one electrode of a plasma display panel, and a second circuit configured to supply a third voltage from a first node of the second circuit to the at least one electrode, the third voltage being between the first voltage and the second voltage. The second circuit includes a first switching transistor controlled by a switching control signal, a second switching transistor controlled by the first switching transistor, the second switching transistor being configured control a connection between a first power terminal and the first node, the first power terminal supplying the first voltage, and a capacitor coupled between the first node and a second power terminal, the second power terminal supplying the second voltage, the capacitor being charged when the second switching transistor is turned on.

### BACKGROUND OF THE INVENTION

1. Field of the Invention

Embodiments relate to a plasma display and associated driver and, more particularly, to a plasma display and driver having a voltage supply circuit that provides an addressing period voltage.

2. Description of the Related Art

A plasma display is a display for displaying characters, images, etc., using plasma generated by a gas discharge. The plasma display may include a plasma display panel (PDP) in which, depending on its size, hundreds of thousands to millions of discharge cells may be arranged in a matrix.

In general, in the plasma display, one field or frame may be divided into a plurality of sub-fields, and gray levels may be represented according to combinations of weight values of the sub-fields. Discharge cells to be turned on and cells not to be turned on may be selected during an address period of each sub-field, and a sustain discharge may be controlled in the cells to be turned on so as to display the desired characters, images, etc.

During the address period, an address pulse may be applied to address electrodes corresponding to discharge cells that are to be turned on. Additionally, an addressing voltage may be applied during the address period to one or more electrodes crossing the address electrodes.

Generally, separate power circuits may be may be included in the plasma display to provide the display electrodes that cross the address electrodes with a high level voltage for a discharge sustain period and the addressing voltage for the address period. However, such separate power circuits tend to decrease the level of integration of the plasma display and may increase the cost thereof. Accordingly, there is a need for a plasma display that uses a smaller number of components, which may reduce the layout area and cost of the plasma display.

The description of the related art provided above is not prior art, but is merely a general overview that is provided to enhance an understanding of the art, and does not necessarily correspond to a particular structure or device.

### SUMMARY OF THE INVENTION

Embodiments are therefore directed to a plasma display and associated driver, which substantially overcome one or more of the problems due to the limitations and disadvantages of the related art.

It is therefore a feature of an embodiment to provide a plasma display and associated driver having a power conversion circuit that converts a voltage applied to electrodes during a sustain period to a voltage applied to the electrodes during an addressing period.

At least one of the above and other features and advantages may be realized by providing a display driver, including a first circuit configured to supply a first voltage and a second voltage to at least one electrode of a plasma display panel, and a second circuit configured to supply a third voltage from a first node of the second circuit to the at least one electrode, the third voltage being between the first voltage and the second voltage. The second circuit includes a first switching transistor controlled by a switching control signal, a second switching transistor controlled by the first switching transistor, the second switching transistor being configured control a connection between a first power terminal and the first node, the first power terminal supplying the first voltage, and a capacitor coupled between the first node and a second power terminal, the second power terminal supplying the second voltage, the capacitor being charged when the second switching transistor is turned on.

The second circuit may include a switching controller configured to output the switching control signal to a control terminal of the first switching transistor, the first switching transistor being turned on when the switching control signal is at a high level and being turned off when the switching control signal is at a low level.

A first terminal of the second switching transistor may be coupled through a third resistor and a second resistor to the first power terminal, and a second terminal of the second switching transistor may be coupled to a first terminal of the capacitor, and a first terminal of the capacitor may be coupled to an output for the at least one electrode, and a second terminal of the capacitor is commonly coupled a first terminal of the first switching transistor and the second power terminal. The third resistor may have a smaller resistance value than the fourth resistor.

The second resistor may have a first terminal coupled to the first power terminal and may have a second terminal coupled to a control terminal of the second switching transistor, a fourth resistor may have a first terminal commonly coupled to the second terminal of the second resistor and the control terminal of the second switching transistor, and may have a second terminal commonly coupled to the second terminal of the capacitor, the second power terminal and the first terminal of the first switching transistor, and the third resistor may have a first terminal commonly coupled to the second terminal of the second resistor and the first terminal of the fourth resistor, and may have a second terminal coupled to the second terminal of the first switching transistor.

The second circuit may further include a Zener diode having a cathode coupled to the control terminal of the second switching transistor and having an anode commonly coupled to the second terminal of the second switching transistor and the first terminal of the capacitor. The second circuit may further include a first resistor having a first terminal coupled to the first power terminal and a second terminal coupled to the first terminal of the second switching transistor.

The first switching transistor may be a bipolar transistor and the second switching transistor may be a field effect transistor. The first and second terminals of the first switching transistor may be an emitter and a collector, respectively, and the first and second terminals of the second switching transistor may be a drain and a source, respectively.

At least one of the above and other features and advantages may also be realized by providing a plasma display, including a plasma display panel having first and second electrodes, and having a third electrode crossing the first and second electrodes, and a first display driver configured to drive the first electrodes, the first display driver including a first circuit coupled to the first electrodes and configured to supply a first voltage and a second voltage to the first electrodes, and a second circuit configured to supply a third voltage from a first node of the second circuit to the first electrodes, the third voltage being between the first voltage and the second voltage. The second circuit may include a first switching transistor controlled by a switching control signal, a second switching transistor controlled by the first switching transistor, the second switching transistor being configured control a connection between a first power terminal and the first node, the first power terminal supplying the first voltage, and a capacitor coupled between the first node and a second power terminal, the second power terminal supplying the second voltage, the capacitor being charged when the second switching transistor is turned on.

The plasma display may further include a second display driver configured to drive the second electrodes, a third display driver configured to drive the third electrodes, and a power supply unit configured to provide the first voltage and the second voltage to each of the first and second display drivers, wherein the first power terminal receives the first voltage from the power supply unit and the second power terminal receives the second voltage from the power supply unit.

The first display driver may drive the first electrodes with a signal alternating between the first and second voltages during a sustain period, and may drive the first electrodes with the third voltage during an address period.

The second circuit may include a switching controller configured to output the switching control signal to a control terminal of the first switching transistor, the first switching transistor being turned on when the switching control signal is at a high level and being turned off when the switching control signal is at a low level.

A first terminal of the second switching transistor may be coupled to the first power terminal, and a second terminal of the second switching transistor may be coupled to a first terminal of the capacitor, and a first terminal of the capacitor may be coupled to the first electrodes, and a second terminal of the capacitor may be commonly coupled a first terminal of the first switching transistor and the second power terminal. The third resistor may have a smaller resistance value than the fourth resistor.

The second resistor may have a first terminal coupled to the first power terminal and may have a second terminal coupled to a control terminal of the second switching transistor, a fourth resistor may have a first terminal commonly coupled to the second terminal of the second resistor and the control terminal of the second switching transistor, and may have a second terminal commonly coupled to the second terminal of the capacitor, the second power terminal and the first terminal of the first switching transistor, and the third resistor may have a first terminal commonly coupled to the second terminal of the second resistor and the first terminal of the fourth resistor, and may have a second terminal coupled to the second terminal of the first switching transistor.

The second circuit may further include a Zener diode having a cathode coupled to a control terminal of the second switching transistor and having an anode commonly coupled to the second terminal of the second switching transistor and the first terminal of the capacitor. The second circuit may further include a first resistor having a first terminal coupled to the first power terminal and a second terminal coupled to the first terminal of the second switching transistor.

The first switching transistor may be a bipolar transistor and the second switching transistor may be a field effect transistor. The first and second terminals of the first switching transistor may be an emitter and a collector, respectively, and the first and second terminals of the second switching transistor may be a drain and a source, respectively.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a schematic block diagram of a plasma display according to an embodiment;

FIG. 2 illustrates driving waveforms of a plasma display according to an embodiment; and

FIG. 3 illustrates a schematic circuit diagram of a sustain electrode driver according to an embodiment.

### DETAILED DESCRIPTION OF THE INVENTION

Korean Patent Application No. 10-2007-0003862, filed on Jan. 12, 2007, in the Korean Intellectual Property Office, and entitled: “Plasma Display Device and Driving Apparatus Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Unless explicitly described to the contrary, terminology such as “an element coupled to another element” includes a state in which the two elements are directly coupled, as well as a state in which the two elements are coupled to one or more additional elements provided between them.

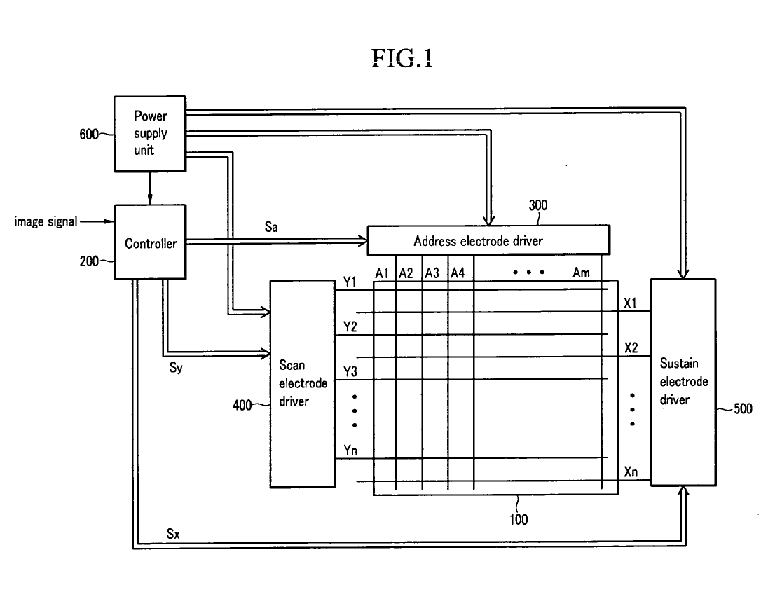

FIGS. 1-3 illustrate a plasma display and an associated driver in which a single voltage conversion unit may be controlled to generate a voltage of a desired level from a sustain voltage and supply it to an electrode, e.g., a scan and/or sustain electrode, during an address period.

FIG. 1 illustrates a schematic block diagram of a plasma display according to an embodiment.

Referring to FIG. 1, the plasma display may include a PDP 100, a controller 200, an address electrode driver 300, a scan electrode driver 400, a sustain electrode driver 500, and a power supply unit 600.

The PDP 100 may include a plurality of address electrodes A1˜Am extending in a column direction and a plurality of sustain electrodes X1˜Xn and scan electrodes Y1˜Yn extending in a row direction. The sustain and scan electrodes X1˜Xn and Y1˜Yn may be arranged in pairs composed of one sustain electrode X and one scan electrode Y. Ends of the sustain electrodes X1˜Xn may be commonly coupled to each other. The PDP 100 may include a substrate on which the sustain electrodes X1˜Xn and the scan electrodes Y1˜Yn are arranged, and a substrate on which the address electrodes A1˜Am are arranged. The two substrates may be disposed to face each other with a discharge space therebetween, such that the scan electrodes Y1˜Yn and the address electrodes A1˜Am cross each other, and the sustain electrodes X1˜Xn and the address electrodes A1˜Am cross each other. Discharge spaces located at each crossing of the address electrodes A1˜Am with the sustain electrodes X1˜Xn and the scan electrodes Y1˜Yn may form discharge cells.

The controller 200 may receive an externally-supplied image signal and may output address electrode driving control signals Sa, sustain electrode driving control signals Sx, and scan electrode driving control signals Sy. The controller 200 may drive the PDP 100 by dividing a single field or frame into a plurality of weighted subfields. Each subfield may include a reset period, an address period, and a sustain period. The sustain period may vary according to the weight of the subfield. In an implementation, the controller 200 may generate a scan high voltage VscH to be applied to a cell that is not addressed during the address period, and may transfer it to the scan electrode driver 400 and/or the sustain electrode driver 500. The scan high voltage VscH may be generated using a DC voltage received from the power supply unit 600.

The address electrode driver 300 may receive the address electrode driving control signals Sa from the controller 200 and may supply display data signals, for selecting discharge cells to be displayed, to each address electrode.

The scan electrode driver 400 may receive the scan electrode driving control signals Sy from the controller 200 and may supply a driving voltage to the scan electrodes Y1˜Yn.

The sustain electrode driver 500 may receive the sustain electrode driving control signals Sx from the controller 200 and may supply a driving voltage to the sustain electrodes X1˜Xn.

The power supply unit 600 may supply power required for driving the plasma display to the controller 200, and to the address, scan and sustain drivers 300, 400, and 500.

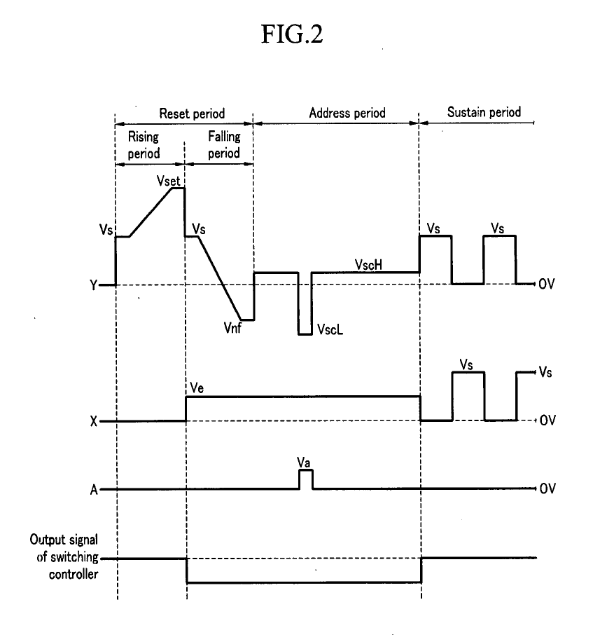

FIG. 2 illustrates driving waveforms of a plasma display according to an embodiment.

The driving waveforms of the plasma display shown in FIG. 2 are driving waveforms of one sub-field, which may include a reset period, an address period and a sustain period, the waveforms corresponding to a change in an input voltage of the sustain electrode X, the scan electrode Y, and an address electrode A under the control of the controller 200.

The reset period may include a rising period and a falling period. During the rising period, the address electrode A and the sustain electrode X may be maintained at a reference voltage, e.g., 0V, and the voltage of the scan electrode Y may be increased gradually from Vs to Vset. The increase of the voltage of the scan electrode Y may cause a weak discharge between the scan electrode Y and the sustain electrode X, and between the scan electrode Y and the address electrode A. Accordingly, negative (−) wall charges may be formed at the scan electrode Y and positive (+) wall charges may be formed at the sustain electrode X and the address electrode A. The sum of wall voltages of each electrode, according to the wall charges formed when the voltage of the scan electrode Y reaches Vset and voltage applied from outside may be equal to a discharge firing voltage Vf. The voltage Vset may be set high enough that discharges occur in the discharge cells regardless of their previous state, such that each cell may be initialized during the reset period.

During the falling period, the address electrode A and the sustain electrode X may be maintained at the reference voltage and a voltage Ve, respectively, and the voltage of the scan electrode Y may be gradually reduced from Vs to Vnf. The reduction of the voltage of the scan electrode Y may cause a weak discharge between the scan electrode Y and the sustain electrode X, and between the scan electrode Y and the address electrode A. Accordingly, negative (−) wall charges which have been formed at the scan electrode Y and positive (+) wall charges which have been formed between the sustain electrode X and the address electrode A may be erased. As a result, negative (−) wall charges at the scan electrode Y, positive (+) wall charges at the sustain electrode X, and positive (+) wall charges at the address electrode A may be reduced. The positive (+) wall charges at the address electrode A may be reduced to an amount suitable for an address operation.

In general, the voltage difference (Vnf-Ve) may be set to be close to the discharge firing voltage Vf between the scan electrode Y and the sustain electrode X, so that a difference between the wall voltages of the scan electrode Y and the sustain electrode X may be about 0V, which may prevent occurrence of an erroneous discharge during the sustain period in a cell for which no address discharge is provided during the address period.

The falling period of the reset period may be provided once per subfield. The rising period may be provided, or not provided, in each subfield according to a control program established for the controller 200. In FIG. 2, the voltage of the scan electrode Y gradually increases and decreases in the ramp pattern, but it will be appreciated that the waveform is not limited thereto, and a waveform of a different pattern may be employed.

During the address period, in order to select cells to be turned-on, the voltage Ve may be supplied to the sustain electrodes X and a scan pulse having scan voltage VscL may be sequentially applied to the scan electrodes Y. Simultaneously, an address voltage may be applied to address electrodes A for those discharge cells that are to be turned-on from among the discharge cells corresponding to the scan electrodes Y to which the voltage VscL is applied. Accordingly, an address discharge may occur between the address voltage-supplied address electrodes A and the VscL voltage-supplied scan electrodes Y, and between the VscL voltage-supplied scan electrodes Y and the sustain electrodes X corresponding to the address voltage-supplied address electrodes A. The address discharge may form positive (+) wall charges on the scan electrodes Y, and negative (−) wall charges on the address electrodes A and the sustain electrodes X.

The voltage VscL may be set to be less than or equal to the voltage Vnf. The voltage VscH (non-scan voltage) may be higher than the voltage VscL and may be supplied to scan electrodes Y to which the voltage VscL is not applied. The reference voltage may be supplied to address electrodes A corresponding to discharge cells that are not selected.

During the sustain period, a sustain discharge pulse that alternately has a high level voltage, e.g., voltage Vs, and a low level voltage, e.g., 0V, may be supplied in opposite phases to the scan electrodes Y and the sustain electrodes X. That is, when the voltage Vs is supplied to the scan electrodes Y, the low level voltage may be supplied to the sustain electrodes X, and when the voltage Vs is supplied to the sustain electrodes X, the low level voltage may be supplied to the scan electrodes Y. Discharge may occur at the scan electrodes Y and the sustain electrodes Y by the wall voltages formed between the scan electrodes Y and the sustain electrodes X by the address discharge. Thereafter, an operation of supplying the sustain discharge pulse to the scan electrodes Y and the sustain electrodes X may be repeatedly performed, e.g., repeated a number of times corresponding to a weight value of the corresponding subfield.

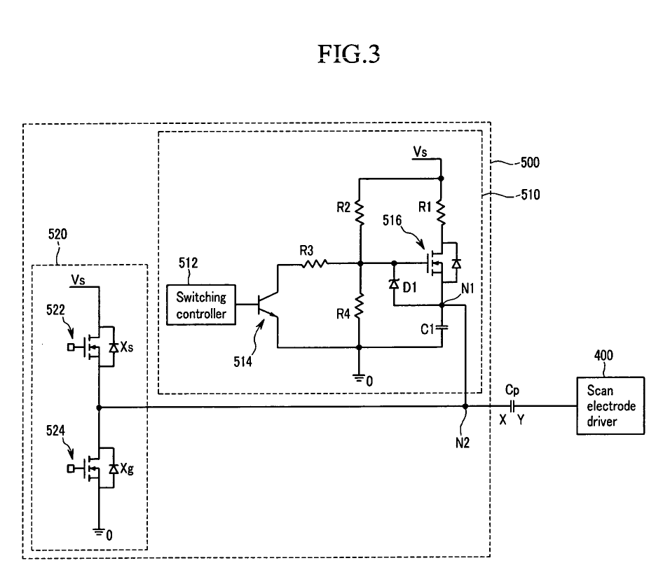

In FIG. 2, a logic output of a switching controller output signal of a sustain electrode driver 500 (see FIG. 3) is also shown, the switching controller controlling the driving waveform of the sustain electrodes X. Details of the sustain electrode driver 500 will be described below in connection with FIG. 3. Although the description below will describe the control of the sustain electrodes X, the single voltage conversion unit described below may applied to scan electrodes Y and/or sustain electrodes X, as noted above.

As shown in FIG. 3, the sustain electrode driver 500 may include a bias voltage generator 510 and a sustain driver 520. The power supply unit 600 may provide the voltage Vs and the low level voltage, e.g., 0V (ground), to each of the scan and sustain drivers 400 and 500. The bias voltage generator 510 may supply the voltage Ve to the sustain electrodes X. The bias voltage generator 510 may include a switching controller 512, a first transistor 514, a second transistor 516, resistors R1-R4, a diode Z1, and a capacitor C1. The bias voltage generator 510 may be coupled to a first power terminal, e.g., a power terminal supplying voltage Vs, and a second power terminal, e.g., a power terminal supplying ground (0V). The first power terminal may receive the voltage Vs from the power supply unit 600 and the second power terminal may receive the ground voltage from the power supply unit 600.

The first transistor 514 may be, e.g., a bipolar transistor, which may have a base coupled to an output terminal of the switching controller 512, an emitter coupled to ground, and a collector coupled to a first terminal of the resistor R3, a second terminal of which may be coupled to a control terminal of the second transistor.

The second transistor 516 may be, e.g., a field effect transistor (FET), which may have a gate coupled to the second terminal of the resistor R3, a drain coupled to a first terminal of the resistor R1, the second terminal of which may be coupled to the Vs power supply, and a source coupled to an output for the sustain electrodes X. In another implementation (not shown), the bipolar transistor 514 and the FET 516 may each be replaced with different switching elements.

The resistor R2 may have a first terminal coupled to the Vs power terminal and the a second terminal coupled to the gate of the FET 516.

The resistor R4 may have a first terminal coupled to the gate of the FET 516 and a second terminal coupled to ground power terminal.

The diode D1 may be, e.g., a Zener diode, which may have a cathode coupled to the gate of the FET 516 and an anode coupled to the output for the X electrodes.

The capacitor C1 may have a first terminal coupled to the output for the X electrodes and a second terminal coupled to ground.

The switching controller 512 may be driven according to a control signal input from the controller 200, and may correspondingly output a high or low level control signal to the bipolar transistor 514.

The bipolar transistor 514 may be turned on or off according to the control signal input from the switching controller 512. A resistance value of the resistor R3 may be set to be smaller than the resistor R4. Accordingly, when the bipolar transistor 514 is turned on, the sustain voltage Vs supplied from the Vs power supply may flow to ground through the resistors R2 and R3 and the bipolar transistor 514, the FET 516 may be turned off, and the voltage Ve may not be supplied to the sustain electrodes X. Conversely, when the bipolar transistor 514 is turned off, the sustain voltage Vs supplied from the Vs power supply may flow to ground through the resistors R2 and R4, voltage distributed according to a ratio of the resistance values of the resistors R2 and R4 may be supplied to the gate of the FET 516, and the FET 516 may be turned on.

When the FET 516 is turned on, the voltage Ve may be charged in the capacitor C1 and supplied to the sustain electrodes X. As the FET 516 is turned on, the resistor R1 and the capacitor C1 may operate as a RC series circuit, and the capacitor C1 may be charged by current flowing from the Vs power terminal through the resistor R1 and the FET 516. The voltage charged in the capacitor C1 may be supplied to sustain electrodes X, and the voltage level of sustain electrodes X may rise to the voltage Ve. The capacitor C1 may have a suitable capacity to prevent the voltage level of sustain electrodes X from exceeding the voltage Ve.

As described above, the FET 516 may be controlled to be turned on or off according to the control signal output from the switching controller 512 and, accordingly, the voltage Ve may be selectively applied to the sustain electrodes X. Referring again to FIG. 2, an output signal of the switching controller 512 for generating the driving waveforms of the sustain electrodes X may change to a low level simultaneously with a lowering of the voltage applied to the scan electrodes Y during the reset period. Further, the output signal of the switching controller 512 may change to a high level simultaneously with the start of the sustain period. Because the FET 516 may be turned on when the output signal of the switching controller 512 has the low level and may be turned off when the output signal of the switching controller 512 has the high level, the sustain electrode driver 500 may supply the voltage Ve to the sustain electrodes X starting from the point at which the voltage applied to the scan electrodes Y is lowered during the reset period to the point at which the sustain period starts.

Referring again to FIG. 3, the Zener diode D1 may prevent damage of the FET 516 when a voltage applied to the gate of the FET 516 after being distributed according to the ratio of the resistance values of the resistors R2 and R4 exceeds a predetermined level. When the voltage applied to the gate of the FET 516 exceeds the predetermined level, the Zener diode D1 may use it to charge the capacitor C1 and may transfer only a voltage with a level suitable for a turn-on operation to the gate of the FET 516.

In another implementation (not shown), the bias voltage generator 510 may additionally have a second diode installed on the connection to the sustain electrodes X, e.g., having an anode coupled to the first terminal of the capacitor C1 at a node N1 in FIG. 3 and having a cathode coupled to the sustain electrodes X at a node N2 in FIG. 3. In this case, the capacitor C1 may be replaced by a capacitor with a smaller withstand voltage, which may be advantageous not only for reducing costs for implementing the circuit, but also for reducing ripple of the capacitor C1 according to turn-on or turn-off operation of the FET 516. Thus, the life span of the capacitor C1 may be lengthened and reliability of the output signal of the bias voltage generator 510 may be enhanced.

The sustain driver 520 may supply the voltage Vs to the sustain electrodes X during the sustain period of the subfields. In an implementation, the sustain driver 520 may include a FET 522 having a drain coupled to a power input that supplies the sustain voltage Vs and a source coupled with the sustain electrodes X. The sustain driver 520 may also include a FET 524 having a drain coupled to the sustain electrodes X and a source coupled to ground. The FETs 522 and 524 may be driven according to a control signal input from the controller 200, respectively, to output the voltage Vs to the sustain electrodes X during the sustain period. In an implementation (not shown), the sustain driver 520 may additionally include an energy recovery circuit (ERC).

In another implementation (not shown), the bias voltage generator 510 may be included in the scan electrode driver 400, such that a bias voltage generated by the bias voltage generator 510 during the address period may be applied to the scan electrodes Y, and the sustain electrode driver 500 may supply a different voltage to the sustain electrodes X depending on whether or not the panel capacitor Cp is discharged during the sustain period.

As described above, the plasma display according to an example embodiment may be implemented with high integration at a low cost by including the bias voltage generator 510 as a single circuit integrated into the sustain electrode driver 500 and/or the scam electrode driver 400. The bias voltage generator 510 may use the voltage Vs as power, i.e., may use the power source for the voltage Vs supplied by the sustain driver 520 to the electrodes. The bias voltage generator 510 may thus use voltages provided by the power supply unit 600 (see FIG. 1) to generate the desired level of voltage, i.e., Ve. The bias voltage generator 510 may convert the level of the voltage Vs in the sustain electrode driver 500 and/or the scan electrode driver 400 to supply the generated voltage Ve during the address period. Thus, a reduction in the number of components, a reduction in the layout area, and a reduction in costs may be achieved.

Example embodiments have been disclosed herein, and although specific terms are employed, they are used and are to be interpreted in a generic and descriptive sense only and not for purpose of limitation. Thus, it will be understood by those of ordinary skill in the art that various changes in form and details may be made without departing from the spirit and scope of the present invention as set forth in the following claims.

What is claimed is:

1. A display driver, comprising:
a first circuit configured to supply a first voltage and a second voltage to at least one electrode of a plasma display panel; and
a second circuit configured to supply a third voltage from a first node of the second circuit to the at least one electrode, the third voltage being between the first voltage and the second voltage, wherein the second circuit includes:
a first switching transistor controlled by a switching control signal,
a second switching transistor controlled by the first switching transistor, the second switching transistor being configured control a connection between a first power terminal and the first node, the first power terminal supplying the first voltage, and
a capacitor coupled between the first node and a second power terminal, the second power terminal supplying the second voltage, the capacitor being charged when the second switching transistor is turned on.

2. The display driver as claimed in claim 1, wherein the second circuit includes a switching controller configured to output the switching control signal to a control terminal of the first switching transistor, the first switching transistor being turned on when the switching control signal is at a high level and being turned off when the switching control signal is at a low level.

3. The display driver as claimed in claim 1, wherein a first terminal of the second switching transistor is coupled through a third resistor and a second resistor to the first power terminal, and a second terminal of the second switching transistor is coupled to a first terminal of the capacitor, and
a first terminal of the capacitor is coupled to an output for the at least one electrode, and a second terminal of the capacitor is commonly coupled a first terminal of the first switching transistor and the second power terminal.

4. The display driver as claimed in claim 3, wherein the third resistor has a smaller resistance value than of the fourth resistor.

5. The display driver as claimed in claim 3, wherein:
the second resistor has a first terminal coupled to the first power terminal and has a second terminal coupled to a control terminal of the second switching transistor;
a fourth resistor has a first terminal commonly coupled to the second terminal of the second resistor and the control terminal of the second switching transistor, and has a second terminal commonly coupled to the second terminal of the capacitor, the second power terminal and the first terminal of the first switching transistor; and
the third resistor has a first terminal commonly coupled to the second terminal of the second resistor and the first terminal of the fourth resistor, and has a second terminal coupled to the second terminal of the first switching transistor.

6. The display driver as claimed in claim 5, wherein the second circuit further includes a Zener diode having a cathode coupled to the control terminal of the second switching transistor and having an anode commonly coupled to the second terminal of the second switching transistor and the first terminal of the capacitor.

7. The display driver as claimed in claim 6, wherein the second circuit further includes a first resistor having a first terminal coupled to the first power terminal and a second terminal coupled to the first terminal of the second switching transistor.

8. The display driver as claimed in claim 1, wherein the first switching transistor is a bipolar transistor and the second switching transistor is a field effect transistor.

9. The display driver as claimed in claim 8, wherein the first and second terminals of the first switching transistor are an emitter and a collector, respectively, and the first and second terminals of the second switching transistor are a drain and a source, respectively.

10. A plasma display, comprising:
a plasma display panel having first and second electrodes, and having a third electrode crossing the first and second electrodes; and
a first display driver configured to drive the first electrodes, the first display driver including:
a first circuit coupled to the first electrodes and configured to supply a first voltage and a second voltage to the first electrodes; and
a second circuit configured to supply a third voltage from a first node of the second circuit to the first electrodes, the third voltage being between the first voltage and the second voltage, wherein the second circuit includes:
a first switching transistor controlled by a switching control signal,
a second switching transistor controlled by the first switching transistor, the second switching transistor being configured control a connection between a first power terminal and the first node, the first power terminal supplying the first voltage, and
a capacitor coupled between the first node and a second power terminal, the second power terminal supplying the second voltage, the capacitor being charged when the second switching transistor is turned on.

11. The plasma display as claimed in claim 10, further comprising:
a second display driver configured to drive the second electrodes;
a third display driver configured to drive the third electrodes; and
a power supply unit configured to provide the first voltage and the second voltage to each of the first and second display drivers, wherein the first power terminal receives the first voltage from the power supply unit and the second power terminal receives the second voltage from the power supply unit.

12. The plasma display as claimed in claim 10, wherein the first display driver drives the first electrodes with a signal alternating between the first and second voltages during a sustain period, and drives the first electrodes with the third voltage during an address period.

13. The plasma display as claimed in claim 10, wherein the second circuit includes a switching controller configured to output the switching control signal to a control terminal of the first switching transistor, the first switching transistor being turned on when the switching control signal is at a high level and being turned off when the switching control signal is at a low level.

14. The plasma display as claimed in claim 10, wherein a first terminal of the second switching transistor is coupled to the first power terminal, and a second terminal of the second switching transistor is coupled to a first terminal of the capacitor, and
a first terminal of the capacitor is coupled to the first electrodes, and a second terminal of the capacitor is commonly coupled a first terminal of the first switching transistor and the second power terminal.

15. The plasma display as claimed in claim 14, wherein the third resistor has a smaller resistance value than of the fourth resistor.

16. The plasma display as claimed in claim 14, wherein:
the second resistor has a first terminal coupled to the first power terminal and has a second terminal coupled to a control terminal of the second switching transistor;
a fourth resistor has a first terminal commonly coupled to the second terminal of the second resistor and the control terminal of the second switching transistor, and has a second terminal commonly coupled to the second terminal of the capacitor, the second power terminal and the first terminal of the first switching transistor; and
the third resistor has a first terminal commonly coupled to the second terminal of the second resistor and the first terminal of the fourth resistor, and has a second terminal coupled to the second terminal of the first switching transistor.

17. The plasma display as claimed in claim 16, wherein the second circuit further includes a Zener diode having a cathode coupled to a control terminal of the second switching transistor and having an anode commonly coupled to the second terminal of the second switching transistor and the first terminal of the capacitor.

18. The plasma display as claimed in claim 17, wherein the second circuit further includes a first resistor having a first terminal coupled to the first power terminal and a second terminal coupled to the first terminal of the second switching transistor.

19. The plasma display as claimed in claim 10, wherein the first switching transistor is a bipolar transistor and the second switching transistor is a field effect transistor.

20. The plasma display as claimed in claim 19, wherein the first and second terminals of the first switching transistor are an emitter and a collector, respectively, and the first and second terminals of the second switching transistor are a drain and a source, respectively.
